(19) United States
(12) Patent Application Publication
(10) Pub. No.: US 2026/0186527 A1
(43) Pub. Date: Jul. 2, 2026

(54) Display Device

(71) Applicant: LG Display Co., Ltd., Seoul (KR)

(72) Inventor: ChangHee Choi, Seoul (KR)

(21) Appl. No.: 19/415,091

(22) Filed: Dec. 10, 2025

(30) Foreign Application Priority Data
Dec. 30, 2024 (KR) 10-2024-0199793

(51) Int. Cl. G06F 1/16; F16M 11/08

(52) U.S. Cl. CPC G06F 1/1601; F16M 11/08; G06F 2200/1612

(57) ABSTRACT

A display device presented herein includes a display module and a bending unit for bending the display module. The bending unit includes a cam wheel rotatably disposed on a rear surface of the display module, and an operating arm connected to the display module for bending the display module and linearly moving by the rotation of the cam wheel.

### CROSS-REFERENCE TO RELATED APPLICATION

The present application claims priority to Republic of Korea Patent Application No. 10-2024-0199793 filed on Dec. 30, 2024, which is incorporated herein by reference in its entirety.

### FIELD

The present disclosure relates to a display device, and more particularly, to a display device capable of bending a display module.

### BACKGROUND

In general, flat type display devices include a liquid crystal display device, a plasma display device, a field emission display device, and a light emitting display device, but the liquid crystal display device and the light emitting display device are in the spotlight due to advantages of mass production technology, ease of driving means, and implementation of high quality.

Recently, in addition to the technical research and development of flat panel display devices, the need for research and development has been highlighted in terms of product design that can more appeal to consumers, and accordingly, the demand for curved display devices or curved display devices having curvature in the display devices is gradually increasing.

In particular, since the size of the panel is gradually increasing in recent years, a display device capable of innovatively changing the curvature is being developed along with the slimness required by consumers.

### SUMMARY

An object to be achieved by the present disclosure is to provide a display device capable of adjusting a curvature of a display module by bending a display module.

Another problem to be solved by the present disclosure is to provide a display device capable of partially bending one side portion of both side portions of a display module.

Objects of the present disclosure are not limited to the above-mentioned objects, and other objects, which are not mentioned above, can be clearly understood by those skilled in the art from the following descriptions.

A display device according to one or more embodiments of the present disclosure includes a display module and a bending unit for bending the display module, and the bending unit include a cam wheel rotatably disposed on a rear surface of the display module, and an operating arm connected to the display module for bending the display module and linearly moving by the rotation of the cam wheel.

A display device according to one or more other embodiments of the present disclosure may include a display module and a bending unit disposed on a rear surface of the display module and bending the display module, the bending unit includes a cam wheel including a first cam rail and a second cam rail, a first operating arm and a second operating arm respectively connected to the display module, a first cam follower connected to the first operating arm so as to move along the first cam rail and converting the rotational movement of the cam wheel into a linear movement of the first operating arm, and a second cam follower connected to the second operating arm so as to move along the second cam rail and converting the rotational movement of the cam wheel into a linear movement of the second operating arm.

A display device according to one or more other embodiments of the present disclosure may include a display module and a bending unit disposed on a surface of the display module, the bending unit configured to bend the display module. The bending unit comprises a cam wheel including a first cam rail and a second cam rail, a first cam follower connected to the first cam rail, a second cam follower connected to the second cam rail, a first operating arm connected to the first cam follower and a first side portion of the display module, the first operating arm configured to apply a force capable of bending the first side portion of the display module, and a second operating arm connected to the second cam follower and a second side portion of the display module, the second operating arm configured to apply a force capable of bending the second side portion of the display module. The display module is bent by at least one of a movement of the first operating arm and a movement of the second operating arm due to at least one of a movement of the first cam follower along the first cam rail and a movement of the second cam follower along the second cam rail, caused by a rotational movement of the cam wheel.

Other detailed matters of the embodiments are included in the detailed description and the drawings.

According to one or more embodiments of the present disclosure, the curvature of the display module may be adjusted by bending the display module.

In the present disclosure, one side portion of both side portions of the display module may be partially bent.

According to one or more embodiments of the present disclosure, the curvature of the display module may be variously changed, and thus an optimal viewing experience may be provided according to a user's preference or a viewing environment.

The present disclosure optimizes the viewing angle by adjusting the curvature of the display module, so that high-quality images can be provided to all users even when multiple users watch at the same time.

The effects according to the present disclosure are not limited to the contents exemplified above, and more various effects are included in the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a front view of a display device according to one or more embodiments of the present disclosure.

FIG. 2 is a rear view illustrating a display device according to one or more embodiments of the present disclosure.

FIG. 3 is a plan view of a display device according to one or more embodiments of the present disclosure.

FIG. 4A illustrates that a display module of a display device maintains a basic mode according to one or more embodiments of the present disclosure.

FIG. 4B illustrates a state in which the display module of the display device is deformed to the entire bending mode according to one or more embodiments of the present disclosure.

FIG. 5A illustrates that a display module of a display device maintains a basic mode according to one or more other embodiments of the present disclosure.

FIG. 5B illustrates a state in which a display module of a display device is deformed to a partial bending mode according to one or more other embodiments of the present disclosure.

FIG. 6 is a plan view illustrating a state in which a display module of a display device is deformed to a partial bending mode according to one or more other embodiments of the present disclosure.

FIG. 7A illustrates that a display module of a display device maintains a basic mode according to one or more other embodiments of the present disclosure.

FIG. 7B illustrates a state in which a display module of a display device is deformed to a first partial bending mode according to one or more other embodiments of the present disclosure.

FIG. 7C illustrates a state in which the display module of the display device is deformed to the second partial bending mode according to one or more other embodiments of the present disclosure.

FIG. 7D illustrates a state in which the display module of the display device is deformed to the entire bending mode according to one or more other embodiments of the present disclosure.

FIG. 8 illustrates a part of a bending unit of a display device according to one or more other embodiments of the present disclosure.

FIG. 9 is a perspective view of a display device when viewed from a rear surface according to one or more other embodiments of the present disclosure.

FIG. 10 is an enlarged view of a part of FIG. 9.

FIG. 11 is an exploded perspective view of a display device according to one or more other embodiments of the present disclosure.

### DETAILED DESCRIPTION

Advantages and characteristics of the present disclosure and a method of achieving the advantages and characteristics will be clear by referring to embodiments described below in detail together with the accompanying drawings. However, the present disclosure is not limited to the embodiments disclosed herein but will be implemented in various forms. The embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the embodiments of the present disclosure are merely examples, and the present disclosure is not limited thereto. Further, in the following description of the present disclosure, a detailed explanation of known related technologies may be omitted to avoid unnecessarily obscuring the subject matter of the present disclosure. The terms such as “including,” “having,” and “comprising” used herein are generally intended to allow other components to be added unless the terms are used with the term “only”. Any references to singular may include plural unless expressly stated otherwise.

Components are interpreted to include an ordinary error range even if not expressly stated.

When the position relation between two parts is described using the terms such as “on”, “above”, “below”, and “next”, one or more parts may be positioned between the two parts unless the terms are used with the term “immediately” or “directly”.

When an element or layer is disposed “on” another element or layer, another layer or another element may be interposed directly on the other element or therebetween.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

Like reference numerals generally denote like elements throughout the disclosure.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, exemplary embodiments of the present disclosure will be described in detail with reference to accompanying drawings.

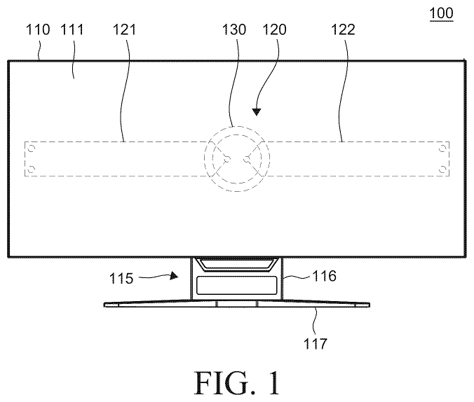

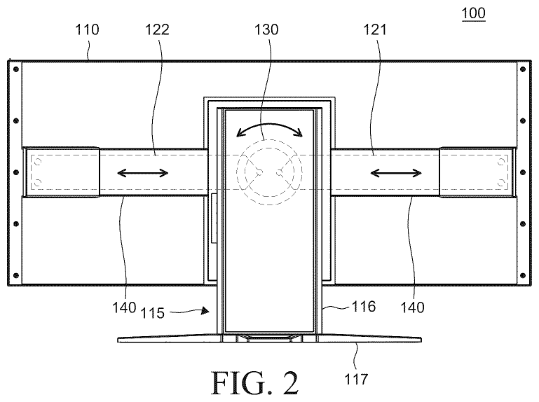

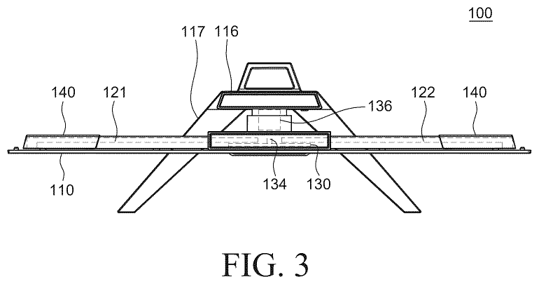

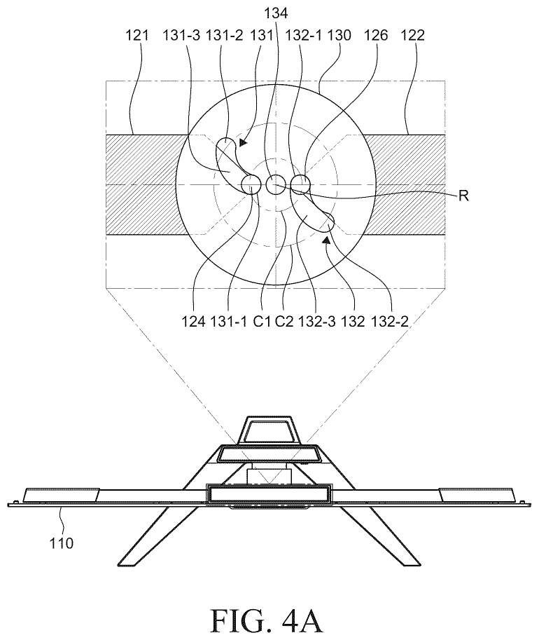

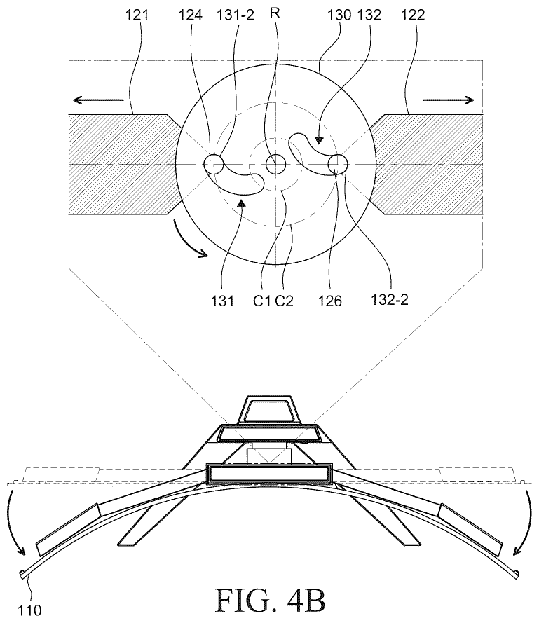

FIG. 1 is a front view of a display device according to one or more embodiments of the present disclosure. FIG. 2 is a rear view illustrating a display device according to one or more embodiments of the present disclosure. FIG. 3 is a plan view of a display device according to one or more embodiments of the present disclosure. FIG. 4A illustrates that a display module of a display device maintains a basic mode according to one or more embodiments of the present disclosure. FIG. 4B illustrates a state in which the display module of the display device is deformed to the entire bending mode according to one or more embodiments of the present disclosure.

Referring to FIGS. 1 to 4B, a display device 100 according to one or more embodiments of the present disclosure includes a display module 110, a stand 115, and a bending unit 120.

The display module 110 may be transformed into a basic mode, a partial bending mode, and an entire bending mode by the bending unit 120. In the basic mode, the display module 110 is not deformed by the bending unit 120. In this state, the display module 110 may be flat or in an initial state bent at a preset basic curvature. In the partial bending mode, only one of the left and right side portions of the display module 110 is bent. For example, only the left side portion may be bent and the right side may not be deformed, or on the contrary, only the right side portion may be bent and the left side may not be deformed. In the case of the entire bending mode, both left and right side portions of the display module 110 are bent.

The display module 110 is a component for providing images and sound to a user. To this end, various components for providing such an image and sound may be mounted inside the display module 110. The display module 110 includes a display panel 111.

The display panel 111 may be any one of a plasma display panel, a liquid crystal display, an organic light emitting diode display, and a light emitting diode display.

The display panel 111 may be formed of a curved display or a flexible display rather than a flat panel display. Further, the display panel 111 may be configured as a touch type display.

The stand 115 supports the display module 110. The stand 115 is disposed at the rear of the display module 110 and is seated on a desk or a table to stably support the display module 110.

The stand 115 includes a base frame 116 and a base 117.

The base frame 116 is disposed so that at least a part of the base frame 116 faces the rear surface of the display module 110 and is connected to the display module 110. A power cable and various interface cables for supplying power to the display module 110 may be mounted on the base frame 116. The base frame 116 may be configured to support the display module 110 so as to be adjustable in height.

The base 117 is disposed at a lower end of the base frame 116 and may be mounted on a desk or a table. The base 117 may be detachably coupled to the base frame 116. When the base 117 is coupled to the base frame 116, the display device 100 may be installed in a stand type. Further, when the base 117 is separated from the base frame 116, the display device 100 may be installed in a wall-mount type. The base frame 116 may include a component that may be hung on a wall.

The bending unit 120 may be configured to deform the display module 110 by applying a physical force directly or indirectly to the display module 110. The bending unit 120 may transform the display module 110 into a basic mode or a bending mode.

When the bending unit 120 does not apply a force to the display module 110, the display module 110 may maintain a basic mode. For example, as illustrated in FIG. 4A, when the display module 110 includes a flat panel display, the display module 110 may maintain a flat shape in the basic mode. If the display module 110 includes a curved display, the display module 110 may maintain a curved shape with a preset basic curvature in the basic mode.

When the bending unit 120 applies a force to the side portion of the display module 110, the display module 110 may be deformed into a bending mode. For example, as shown in FIG. 4B, the bending unit 120 applies a force to both side portions of the display module 110 so that both side portions of the display module 110 may be bent simultaneously.

The side portion of the display module 110 may represent a portion including an edge of the display module 110. For example, the left or right side portion of the display module 110 may be an area including an edge among the corresponding half portion. Specifically, the left side portion may refer to an area including a left edge of the left half, and the right side portion may refer to an area including a right edge of the right half.

The bending unit 120 comprises a pair of operating arms 121, 122 connected to the display module 110, cam followers 124, 126 respectively disposed on the pair of operating arms 121, 122, a cam wheel 130 comprising a pair of cam rails 131, 132, and a driving unit 136 for providing a rotational force to the cam wheel 130.

The pair of operating arms 121 and 122 are connected to both side portions of the display module 110, respectively, to apply a force capable of bending the display module 110 to the display module 110. The pair of operating arms 121 and 122 may be bent along the display module 110 when the display module 110 is bent. The pair of operating arms 121 and 122 may be disposed to face the rear surface of the display module 110. In addition, the pair of operating arms 121 and 122 may be disposed one on each side of the rotation center R of the cam wheel 130, but is not limited thereto.

The first operating arm 121 of the pair of operating arms 121 and 122 may bend one side portion of the display module 110. For example, the first operating arm 121 is connected to the left side portion of the display module 110 so as to bend the left side portion of the display module 110. One end of the first operating arm 121 may be fixed to one side portion of the display module 110, and the other end may be disposed to face the cam wheel 130. For example, one end of the first operating arm 121 may be fixed to a left edge of the display module 110 or a portion spaced apart from the center of the display module 110 by a predetermined distance toward the left edge.

The first cam follower 124 is disposed at the other end of the first operating arm 121. The first operating arm 121 is connected to the cam wheel 130 through the first cam follower 124 and may linearly move according to the rotation of the cam wheel 130.

The first operating arm 121 may be covered and protected by the cover 140 disposed on the rear surface of the display module 110. The cover 140 may serve as a guide for supporting the first operating arm 121 to perform a linear motion. By supporting the first operating arm 121 to linearly move, when the first operating arm 121 receives the driving force of the cam wheel 130 through the first cam follower 124, the cover 140 may stably linearly move without being twisted or unevenly bent.

The second operating arm 122 of the pair of operating arms 121 and 122 may push and bend the other side portion of the display module 110. For example, the second operating arm 122 is connected to the right side portion of the display module 110 to bend the right side portion of the display module 110. One end of the second operating arm 122 may be fixed to the other side portion of the display module 110, and the other end may be disposed to face the cam wheel 130. For example, one end of the second operating arm 122 may be fixed to the right edge of the display module 110 or a portion spaced apart from the center of the display module 110 by a predetermined distance toward the right edge. The other second cam follower 126 is disposed at the other end of the second operating arm 122, and the second operating arm 122 is connected to the cam wheel 130 through the second cam follower 126.

Like the first operating arm 121, the second operating arm 122 may be covered, protected, and guided by the cover 140. By supporting the second operating arm 122 to linearly move, when the second operating arm 122 receives the driving force of the cam wheel 130 through the second cam follower 126, the cover 140 may stably linearly move without being twisted or unevenly bent.

Cam followers 124, 126 are respectively disposed on the pair of operating arms 121, 122 to transmit the driving force of the cam wheel 130 to the pair of operating arms 121, 122.

Specifically, the first cam follower 124 is disposed at the other end of the first operating arm 121 and connects the first operating arm 121 and the cam wheel 130. The first cam follower 124 may transmit the driving force of the cam wheel 130 to the first operating arm 121 when the cam wheel 130 rotates. That is, the first cam follower 124 may convert the rotational motion of the cam wheel 130 into a linear motion of the first operating arm 121. The first cam follower 124 is inserted into the first cam rail 131 among a pair of cam rails 131 and 132 included in the cam wheel 130. The first cam follower 124 may linearly move the first operating arm 121 by moving along the first cam rail 131 when the cam wheel 130 rotates.

The first cam follower 124 may be implemented in various forms. For example, the first cam follower 124 may be formed in the form of a roller that is rotatably disposed with respect to the first operating arm 121, or may be formed in a fixed shape so as not to rotate.

The second cam follower 126 is disposed at the other end of the second operating arm 122 and connects the second operating arm 122 and the cam wheel 130. The second cam follower 126 may transmit the driving force of the cam wheel 130 to the second operating arm 122 when the cam wheel 130 rotates. That is, the second cam follower 126 may convert a rotational motion of the cam wheel 130 into a linear motion of the second operating arm 122. The second cam follower 126 is inserted into the second cam rail 132 among the pair of cam rails 131 and 132 included in the cam wheel 130. The second cam follower 126 may linearly move the second operating arm 122 by moving along the second cam rail 132 when the cam wheel 130 rotates.

The second cam follower 126 may be implemented in various forms. For example, the second cam follower 126 may be formed in the form of a roller that is rotatably disposed with respect to the second operating arm 122, or may be formed in a fixed shape so as not to rotate.

The cam wheel 130 is spaced apart from the display module 110 so as to face the rear surface of the display module 110. The drawing indicates that the cam wheel 130 is located between the display module 110 and the operating arms 121 and 122, but the position may be changed. For example, the cam wheel 130 may be disposed farther from the display module 110 than the operating arms 121 and 122.

The cam wheel 130 may be rotatably supported on the base frame 116 and is connected to the driving unit 136 through the rotation shaft 134. The cam wheel 130 may rotate clockwise or counterclockwise about the rotation shaft 134. The cam wheel 130 may be basically disposed in a central portion of the display module 110, but its position may be variously adjusted as necessary.

The first cam rail 131 and the second cam rail 132 may be disposed on both sides of the rotation center R of the cam wheel 130. For example, the first cam rail 131 may be disposed to be biased toward the left side portion of the display module 110 from the rotation center R of the cam wheel 130, and the second cam rail 132 may be disposed to be biased toward the right side portion of the display module 110 from the rotation center R of the cam wheel 130. However, the shapes, lengths, and positions of the first cam rail 131 and the second cam rail 132 may be variously changed.

The first cam rail 131 may have a curved shape extending in the radial direction of the cam wheel 130. For example, the first cam rail 131 may be implemented in an arcuate shape, an arc shape, or a parabolic shape. A part of the first cam rail 131 may be located on a virtual first concentric circle C1 that shares the rotation center R with the cam wheel 130, and another part of the first cam rail 131 may be located on a virtual second concentric circle C2 which is larger than the first concentric circle C1 and sharing the rotation center R with the cam wheel 130. Specifically, the first cam rail 131 may include a first end section 131-1 positioned on the first concentric circle C1, a second end section 131-2 positioned on the second concentric circle C2, and a first curve section 131-3 connecting the two end sections 131-1 and 131-2.

Similar to the first cam rail 131, the second cam rail 132 may have a bent shape extending in the radial direction of the cam wheel 130. For example, the second cam rail 132 may be implemented in an arcuate shape, an arc shape, or a parabolic shape. The second cam rail 132 is also positioned over the first concentric circle C1 and the second concentric circle C2. Specifically, the second cam rail 132 includes a third end section 132-1 on the first concentric circle C1, a fourth end section 132-2 on the second concentric circle C2, and a second curve section 132-3 connecting the two end sections 132-1, 132-2. The configuration of the second cam rail 132 is similar to that of the first cam rail 131, but a specific shape or length of each section may be different.

The cam wheel 130 may rotate so that the first cam follower 124 moves between the first end section 131-1 and the second end section 131-2, and the second cam follower 126 moves between the third end section 132-1 and the fourth end section 132-2. That is, the cam wheel 130 may rotate so that the first cam follower 124 stops at the first end section 131-1 or the second end section 131-2, and the second cam follower 126 stops at the third end section 132-1 or the fourth end section 132-2.

Since the first cam follower 124 moves between the first end section 131-1 and the second end section 131-2 of the first cam rail 131, the linear motion stroke of the first operating arm 121 is equal to the difference in radius between the first concentric circle C1 and the second concentric circle C2. That is, the first operating arm 121 may linearly move by a radius difference between the first concentric circle C1 and the second concentric circle C2.

The second cam follower 126 moves between the third end section 132-1 and the fourth end section 132-2 of the second cam rail 132. Accordingly, like the first operating arm 121, the linear motion stroke of the second operating arm 122 is equal to the difference in radius between the second concentric circle C2 and the first concentric circle C1.

A specific configuration of the cam wheel 130 is not limited to that illustrated. For example, the cam wheel 130 may include other types of cam rails other than the groove shape. The configurations of the cam followers 124 and 126 may also be changed according to the shape of the cam rails.

The driving unit 136 is connected to the cam wheel 130 through the rotation shaft 134 and provides a rotational force to the cam wheel 130. The driving unit 136 may be installed in the base frame 116. The driving unit 136 may include a motor or other devices or components capable of providing rotational force. The driving unit 136 is controlled by a controller (not shown) and may rotate the cam wheel 130 clockwise or counterclockwise by a preset angle.

Further, the driving unit 136 may restrict the rotation of the cam wheel 130 in the non-operation state. When the display module 110 is bent by rotating the cam wheel 130 by a predetermined angle by the driving unit 136, a reaction force to be restored to its original shape is generated in the display module 110. As a result, the cam wheel 130 receives torque in the opposite direction. In this case, the driving unit 136 fixes the cam wheel 130 so that the display module 110 may be maintained in a bent state.

If necessary, the driving unit 136 may be omitted. When the driving unit 136 is omitted, the cam wheel 130 may be configured to be manually rotated by a user. To this end, components for user manipulation, such as a lever and a handle, may be coupled to the cam wheel 130. Further, when the driving unit 136 is omitted, a locking mechanism or a stopper for preventing rotation of the cam wheel 130 due to the restoring force of the display module 110 may be further installed.

In the display device 100 according to one or more embodiments of the present disclosure, the display module 110 may be deformed to a basic mode or a bending mode by the action of the bending unit 120.

As shown in FIG. 4A, when the first cam follower 124 is positioned in the first end section 131-1 of the first cam rail 131 and the second cam follower 126 is positioned in the third end section 132-1 of the second cam rail 132, the display module 110 may maintain the default mode. In this case, the first cam follower 124 does not pressurize the first operating arm 121 to move away from the rotation center R of the cam wheel 130, and the second cam follower 126 does not pressurize the second operating arm 122 to move away from the rotation center R of the cam wheel 130. Accordingly, the display module 110 may be maintained in a flat shape.

As shown in FIG. 4B, when the cam wheel 130 is rotated counterclockwise by the driving unit 136, the first cam follower 124 moves to the second end section 131-2 of the first cam rail 131, and the second cam follower 126 moves to the fourth end section 132-2 of the second cam rail 132. In this case, the display module 110 may be deformed to a bending mode.

That is, the first operating arm 121 moves in a direction away from the rotation center R of the cam wheel 130 by a predetermined stroke and the second operating arm 122 moves in a direction away from the rotation center R of the cam wheel 130 by a predetermined stroke.

Accordingly, the left side portion and the right side portion of the display module 110 are bent. In this case, the first operating arm 121 and the second operating arm 122 may also be bent together with the display module 110. When the first operating arm 121 bends the left side portion of the display module 110, the display module 110 may be gently bent from the center portion to the left edge. Further, when the second operating arm 122 bends the right side portion of the display module 110, the display module 110 may be gently bent from the center portion to the right edge. Accordingly, the display module 110 may be bent as a whole.

After the display module 110 is bent, the driving unit 136 restrains the rotation of the cam wheel 130 so that the display module 110 may be maintained in a bent state.

As described above, in the display device 100 according to one or more embodiments of the present disclosure, the display module 110 is deformed in a curved shape as if surrounding the user in front by the bending unit 120 to provide a realistic image quality and a sense of immersion to the user.

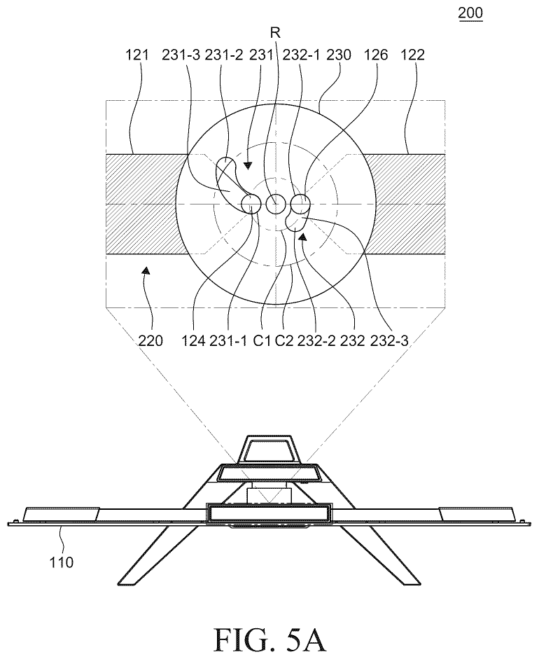

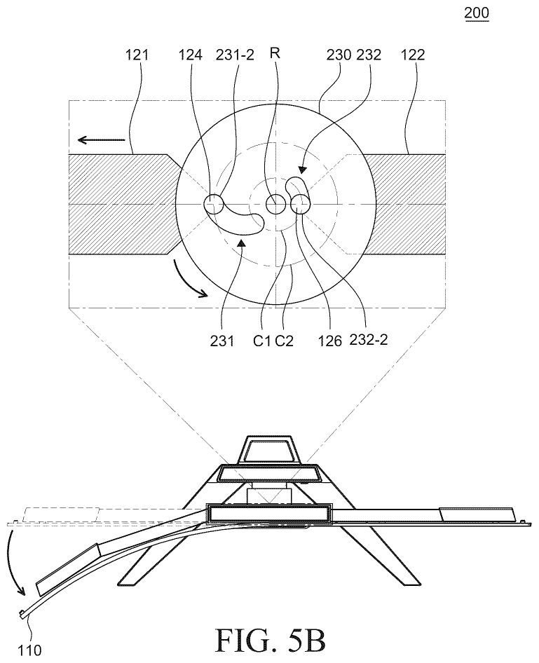

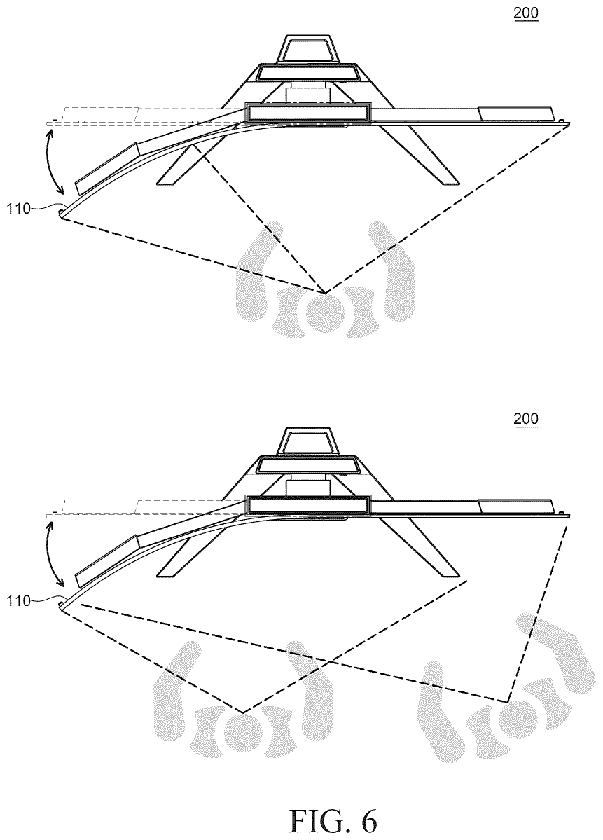

FIG. 5A illustrates that a display module of a display device maintains a basic mode according to one or more other embodiments of the present disclosure. FIG. 5B illustrates a state in which a display module of a display device is deformed to a partial bending mode according to one or more other embodiments of the present disclosure. FIG. 6 is a plan view illustrating a state in which a display module of a display device is deformed to a partial bending mode according to one or more other embodiments of the present disclosure.

Referring to FIGS. 5A and 5B, a display device 200 according to one or more other embodiments of the present disclosure includes a display module 110, a stand 115, and a bending unit 220. The display module 110 and the stand 115 are the same as described above.

The bending unit 220 includes a pair of operating arms 121, 122 connected to the display module 110, cam followers 124, 126 respectively disposed on the pair of operating arms 121, 122, a cam wheel 230 including a pair of cam rails 231, 232, and a driving unit 136 as shown in FIG. 1 for providing rotational force to the cam wheel 230. The pair of operating arms 121 and 122, the pair of cam followers 124 and 126, and the driving unit 136 are the same as described above.

The cam wheel 230 is connected to the first operating arm 121 through the first cam follower 124 and connected to the second operating arm 122 through the second cam follower 126. The cam wheel 230 includes a first cam rail 231 into which the first cam follower 124 is inserted and a second cam rail 232 into which the second cam follower 126 is inserted.

The first cam rail 231 and the second cam rail 232 are disposed on both sides of the rotation center R of the cam wheel 230. For example, the first cam rail 231 may be disposed to be biased toward the left side portion of the display module 110 from the rotation center R of the cam wheel 230, and the second cam rail 232 may be disposed to be biased toward the right side portion of the display module 110 from the rotation center R of the cam wheel 230. However, the shapes, lengths, and positions of the first cam rail 231 and the second cam rail 232 may be variously changed.

The first cam rail 231 may be formed in a curved shape to extend in the radial direction of the cam wheel 230. For example, the first cam rail 231 may have an arcuate shape, an arc shape, and a parabolic shape. A part of the first cam rail 231 may be located on a virtual first concentric circle C1 that shares the rotation center R with the cam wheel 230, and the other part may be located on a virtual second concentric circle C2 which is larger than the first concentric circle C1 and sharing the rotation center R with the cam wheel 230.

Specifically, the first cam rail 231 may include a first end section 231-1 positioned on the first concentric circle C1, a second end section 231-2 positioned on the second concentric circle C2, and a first curve section 231-3 connecting the first end section 231-1 and the second end section 231-2.

The second cam rail 232 may be formed in an arc shape disposed on the first concentric circle C1. For example, the second cam rail 232 may include a third end section 232-1 and a fourth end section 232-2 which are positioned to be spaced apart from each other on the second concentric circle C2, and a second curve section 232-3 which connects the third end section 232-1 and the fourth end section 232-2.

The cam wheel 230 may rotate so that the first cam follower 124 moves between the first end section 231-1 and the second end section 231-2. Since the first cam follower 124 moves between the first end section 231-1 and the second end section 231-2, the first operating arm 121 may move a distance equal to the difference in radius between the first concentric circle C1 and the second concentric circle C2.

In the display device 200 according to one or more other embodiments of the present disclosure, the display module 110 may be deformed to a basic mode or a bending mode by the action of the bending unit 220.

As shown in FIG. 5A, the display module 110 may be maintained in the default mode when the first cam follower 124 is located in the first end section 231-1 of the first cam rail 231 and the second cam follower 126 is located in the third end section 232-1 of the second cam rail 232. In this case, the first cam follower 124 does not pressurize the first operating arm 121 to move away from the rotation center R of the cam wheel 230, and the second cam follower 126 does not pressurize the second operating arm 122 to move away from the rotation center R of the cam wheel 230. Accordingly, the display module 110 may be maintained in a flat shape.

As shown in FIG. 5B, when the cam wheel 230 rotates counterclockwise, the first cam follower 124 may move to the second end section 231-2 of the first cam rail 231, and the second cam follower 126 may move to the fourth end section 232-2 of the second cam rail 232. In this case, the display module 110 may be deformed to a bending mode.

That is, the first operating arm 121 moves in a direction away from the rotation center R of the cam wheel 230 by a preset stroke. In this case, the second operating arm 122 does not move. Accordingly, only the left side portion of the display module 110 is bent. When the first operating arm 121 bends the left side portion of the display module 110, the display module 110 may be gently bent from the center portion to the left edge.

After the display module 110 is bent, the driving unit 136 restrains the rotation of the cam wheel 230 so that the display module 110 may be maintained in a bent state.

As shown in FIG. 6, in the display device 200 according to one or more other embodiments of the present disclosure, the display module 110 is transformed into a curved shape as if surrounding the user in front, thereby providing a realistic image quality and a sense of immersion to the user.

Further, in the display device 200 according to one or more other embodiments of the present disclosure, only one side portion of the display module 110 is partially bent so that when several users simultaneously view the screen of the display device 200, the viewing angle may be optimized to provide good image quality to all users.

The display device 200 according to one or more other embodiments of the present disclosure operates so that the bending unit 220 bends only one side portion of the display module 110, so that the display device 200 may be configured to include one operating arm.

For example, when only the left side portion of the display module 110 is bent, the bending unit 220 may include one operating arm 121 and one cam follower 124 connected to the left side portion of the display module 110. In this case, only one cam rail 231 into which one cam follower 124 is inserted may be disposed on the cam wheel 230.

Further, when only the right side portion of the display module 110 is bent, the bending unit 220 may include one operating arm 122 and one cam follower 126 connected to the right side portion of the display module 110. In this case, only one cam rail into which one cam follower 126 is inserted may be disposed on the cam wheel 230.

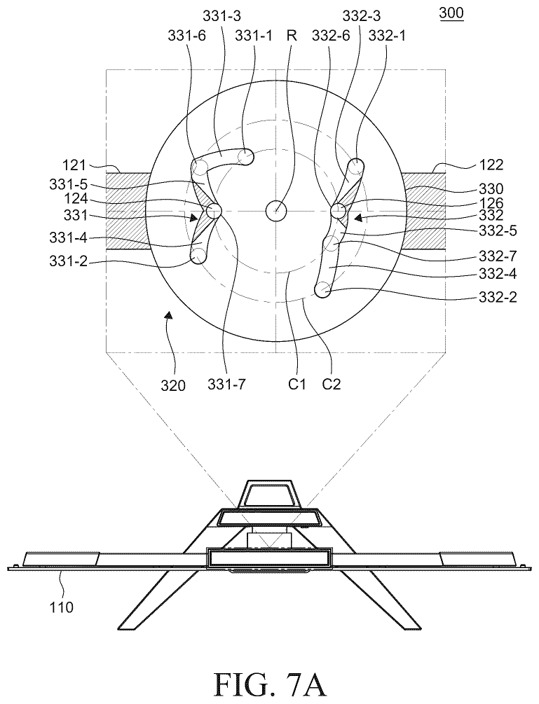

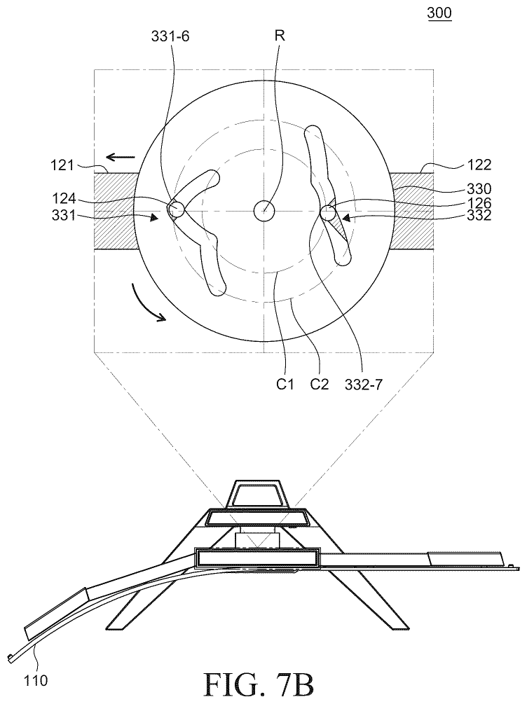

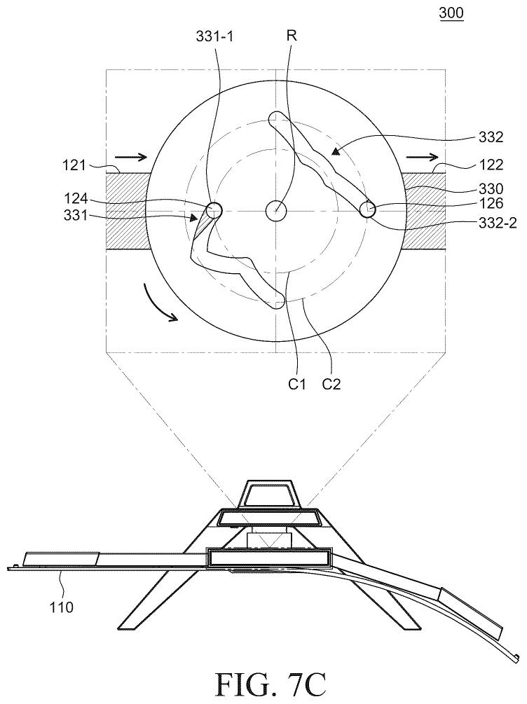

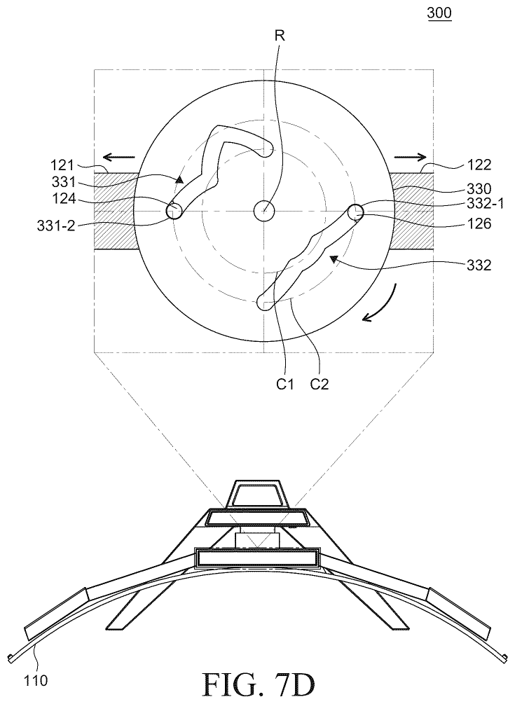

FIG. 7A illustrates that a display module of a display device maintains a basic mode according to one or more other embodiments of the present disclosure. FIG. 7B illustrates a state in which a display module of a display device is deformed to a first partial bending mode according to one or more other embodiments of the present disclosure. FIG. 7C illustrates a state in which the display module of the display device is deformed to the second partial bending mode according to one or more other embodiments of the present disclosure. FIG. 7D illustrates a state in which the display module of the display device is deformed to the entire bending mode according to one or more other embodiments of the present disclosure.

Referring to FIGS. 7A to 7D, a display device 300 according to one or more other embodiments of the present disclosure includes a display module 110, a stand 115, and a bending unit 320. The display module 110 and the stand 115 are the same as described above.

The bending unit 320 comprises a pair of operating arms 121, 122 connected to the display module 110, cam followers 124, 126 respectively disposed on the pair of operating arms 121, 122, a cam wheel 330 on which the pair of cam rails 331, 332 is disposed, and a driving unit 136 as shown in FIG. 1 for providing rotational force to the cam wheel 330. The pair of operating arms 121 and 122, the pair of cam followers 124 and 126, and the driving unit 136 are the same as described above.

The cam wheel 330 is connected to the first operating arm 121 via a first cam follower 124 and to the second operating arm 122 via a second cam follower 126. The cam wheel 330 includes a first cam rail 331 into which a first cam follower 124 is inserted and a second cam rail 332 into which a second cam follower 126 is inserted.

The first cam rail 331 and the second cam rail 332 are disposed on both sides of the rotation center R of the cam wheel 330. For example, the first cam rail 331 may be disposed to be biased toward the left side portion of the display module 110 from the rotation center R of the cam wheel 330, and the second cam rail 332 may be disposed to be biased toward the right side portion of the display module 110 from the rotation center R of the cam wheel 330. However, the shapes, lengths, and positions of the first cam rail 331 and the second cam rail 332 may be variously changed.

The first cam rail 331 and the second cam rail 332 may have different shapes. The first cam rail 331 may be located on a virtual first concentric circle C1 where a part of the first cam rail 331 shares the rotation center R with the cam wheel 330, and the other part of the first cam rail 331 may share the rotation center R with the cam wheel 330 and be located on a virtual second concentric circle C2 larger than the first concentric circle C1. A part of the second cam rail 332 may also be located on the first concentric circle C1, and another part thereof may be located on the second concentric circle C2.

The first cam rail 331 includes a first end section 331-1 positioned on the first concentric circle C1, a second end section 331-2 positioned on the second concentric circle C2, a plurality of curve sections 331-3, 331-4, 331-5 connecting the first end section 331-1 and the second end section 331-2, and a plurality of turning sections 331-6, 331-7 disposed between the plurality of curve sections 331-3, 331-4, 331-5.

Each of the plurality of curve sections 331-3, 331-4, and 331-5 may be formed in a bow-like shape. The plurality of curve sections 331-3, 331-4, 331-5 includes a first curve section 331-3 connected to the first end section 331-1, a second curve section 331-4 connected to the second end section 331-2, and a third curve section 331-3 connected to the first curve section 331-3 and the second curve section 331-4.

The plurality of turning sections 331-6, 331-7 include a first turning section 331-6 disposed on the second concentric circle C2 and a second turning section 331-7 disposed on the first concentric circle C1. The first turning section 331-6 connects the first curve section 331-3 and the third curve section 331-5 to each other. The second turning section 331-7 connects the second curve section 331-4 and the third curve section 331-5.

The second cam rail 332 includes a third end section 332-1 and a fourth end section 332-2 positioned to be spaced apart from each other on the second concentric circle C2, a plurality of curve sections 332-3, 332-4, 332-5 connecting the third end section 332-1 and the fourth end section 332-2, and a plurality of turning sections 332-6, 332-2, 332-5 disposed between the plurality of curve sections 332-3, 332-4, 332-5.

Each of the plurality of curve sections 332-3, 332-4, and 332-5 may be formed in a bow-like curved shape. The plurality of curve sections 332-3, 332-4, and 332-5 includes a fourth curve section 332-3 connected to the third end section 332-1, a fifth curve section 332-4 connected to the fourth end section 332-2, and a sixth curve section 332-5 connected to the fourth curve section 332-3 and the fifth curve section 332-4.

The plurality of turning sections 332-6 and 332-7 include a third turning section 332-6 and a fourth turning section 332-7 which are positioned on the first concentric circle C1 to be spaced apart from each other. The third turning section 332-6 connects the fourth curve section 332-3 and the sixth curve section 332-5. The fourth turning section 332-7 connects the fifth curve section 332-4 and the sixth curve section 332-5.

The cam wheel 330 may rotate so that the first cam follower 124 moves between the first end section 331-1 and the second end section 331-2 and the second cam follower 126 moves between the third end section 332-1 and the fourth end section 332-2. Further, the cam wheel 330 may rotate so that the first cam follower 124 stops at any one of the first end section 331-1, the second end section 331-2, the first turning section 331-6, and the second turning section 331-7, and the second cam follower 126 stops at any one of the third end section 332-1, the fourth end section 332-2, the third turning section 332-6, and the fourth turning section 332-7.

According to the rotation of the cam wheel 330, the first cam follower 124 may stop at the first end section 331-1 or the second turning section 331-7 located on the first concentric circle C1, or at the second end section 331-2 or the first turning section 331-6 located on the second concentric circle C2. Accordingly, the first operating arm 121 may move a distance equal to a radius difference between the first concentric circle C1 and the second concentric circle C2.

Further, according to the rotation of the cam wheel 330, the second cam follower 126 may stop at the third turning section 332-6 or the fourth turning section 332-7 located on the first concentric circle C1, or the third end section 332-1 or the fourth end section 332-2 located on the second concentric circle C2. Accordingly, the stroke of the second operating arm 122 linearly moved by the second cam follower 126 is equal to the difference in radius between the first concentric circle C1 and the second concentric circle C2, like the stroke of the first operating arm 121.

According to the rotation of the cam wheel 330, the first cam follower 124 and the second cam follower 126 may stop on the first concentric circle C1 or the second concentric circle C2. When both the first cam follower 124 and the second cam follower 126 are positioned on the first concentric circle C1, the first operating arm 121 and the second operating arm 122 do not move in the direction of bending the display module 110.

Further, when the first cam follower 124 is positioned on the second concentric circle C2 and the second cam follower 126 is positioned on the first concentric circle C1, the first operating arm 121 linearly moves to bend the display module 110, and the second operating arm 122 does not move.

Further, when the second cam follower 126 is positioned on the second concentric circle C2 and the first cam follower 124 is positioned on the first concentric circle C1, the second operating arm 122 linearly moves in the direction of bending the display module 110, and the first operating arm 121 does not move.

Further, when both the first cam follower 124 and the second cam follower 126 are positioned on the second concentric circle C2, both the first operating arm 121 and the second operating arm 122 move linearly in the direction of bending the display module 110.

In the display device 300 according to one or more other embodiments of the present disclosure, the display module 110 may be deformed to a basic mode or a bending mode by the action of the bending unit 320. The bending mode includes the first partial bending mode, the second partial bending mode, and the entire bending mode.

As shown in FIG. 7A, the display module 110 may maintain the basic mode when the first cam follower 124 is positioned in the second turning section 331-7 of the first cam rail 331 and the second cam follower 126 is positioned in the third turning section 332-6 of the second cam rail 332. In this case, the first operating arm 121 and the second operating arm 122 do not bend the display module 110. Accordingly, the display module 110 may be maintained in a flat shape.

As shown in FIG. 7B, the display module 110 may be deformed to the first partial bending mode when the first cam follower 124 moves to the first turning section 331-6 of the first cam rail 331 and the second cam follower 126 moves to the fourth turning section 332-7 of the second cam rail 332 by rotating the cam wheel 330 by a preset angle in the counterclockwise direction.

In this case, the first operating arm 121 moves in a direction away from the rotation center R of the cam wheel 330 by a preset stroke, and the second operating arm 122 does not move. Accordingly, only the left side portion of the display module 110 is bent. When the first operating arm 121 bends the left side portion of the display module 110, the display module 110 may be gently bent from the center portion to the left edge.

After the left side portion of the display module 110 is bent, the driving unit 136 restricts the rotation of the cam wheel 330 so that the display module 110 may be maintained in a bent state.

As shown in FIG. 7C, the display module 110 may be deformed to the second partial bending mode when the cam wheel 330 rotates by a preset angle in the counterclockwise direction to move the first cam follower 124 to the first end section 331-1 of the first cam rail 331 and the second cam follower 126 to the fourth end section 332-2 of the second cam rail 332.

In this case, the second operating arm 122 moves in a direction away from the rotation center R of the cam wheel 330 by a preset stroke, and the first operating arm 121 does not move. Accordingly, only the right side portion of the display module 110 is bent. When the second operating arm 122 bends the right side portion of the display module 110, the display module 110 may be gently bent from the center portion to the right edge.

After the right side portion of the display module 110 is bent, the driving unit 136 restricts the rotation of the cam wheel 330 so that the display module 110 may be maintained in a bent state.

As shown in FIG. 7D, the display module 110 may be deformed to the full bending mode when the cam wheel 330 is rotated clockwise by a preset angle to move the first cam follower 124 to the second end section 331-2 of the first cam rail 331 and the second cam follower 126 to the third end section 332-1 of the second cam rail 332.

In this case, the first operating arm 121 and the second operating arm 122 move in a direction away from the rotation center R of the cam wheel 330 by a predetermined stroke. Accordingly, both the left side portion and the right side portion of the display module 110 are bent. Accordingly, the display module 110 may be bent as a whole.

After the display module 110 is bent, the driving unit 136 restrains the rotation of the cam wheel 330 so that the display module 110 may be maintained in a bent state.

In the display device 300 according to one or more other embodiments of the present disclosure, the display module 110 may be modified by the bending unit 320 into a first partial bending mode in which only one side part is bent, a second partial bending mode in which only the other side part is bent, and an entire bending mode in which both sides are bent. Accordingly, the curvature of the display module 110 may be more variously changed, so that an optimal viewing experience may be provided according to a user's preference or a viewing environment.

In the display device 300 according to one or more other embodiments of the present disclosure, the rotation direction and rotation angle of the cam wheel 330 may be variously changed.

For example, the cam wheel 330 may rotate at an angle at which the first cam follower 124 stops during the curve sections 331-3, 331-4, and 331-5 of the first cam rail 331. In this case, the left side portion of the display module 110 may be bent with more various curvatures.

Further, the cam wheel 330 may rotate at an angle at which the second cam follower 126 stops in the curve sections 332-3, 332-4, and 332-5 of the second cam rail 332. In this case, the right side portion of the display module 110 may be bent with more various curvatures.

Further, as the cam wheel 330 rotates at a preset angle in a clockwise or counterclockwise direction, the display module 110 may be deformed into a basic mode, a first partial bending mode, a second partial bending mode, and a full bending mode.

In addition, the shapes of the first cam rail 331 and the second cam rail 332 may be variously changed.

For example, the first cam rail 331 and the second cam rail 332 may be disposed to have different strokes of the first operating arm 121 and the second operating arm 122. In this case, either the left side portion and the right side portion of the display module 110 may be bent more.

In addition, the number or position of the curve section and the turning section constituting the first cam rail 331 may be variously changed.

In addition, the number or position of the curve section and the turning section constituting the second cam rail 332 may be variously changed.

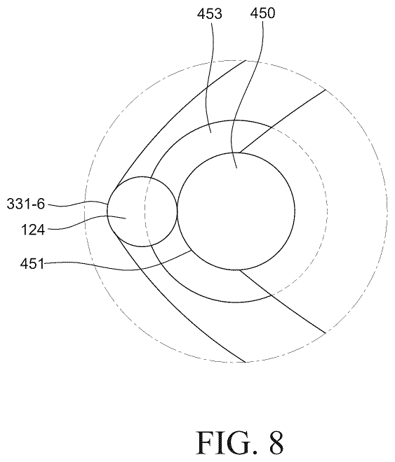

FIG. 8 illustrates a part of a bending unit of a display device according to one or more other embodiments of the present disclosure.

The display device shown in FIG. 8 further includes a retainer 450 disposed in a sharply bent portion of the first cam rail 331 to support the cam follower 124. The retainer 450 is disposed in a first turning section 331-6, which is a connection portion between a first curve section 331-3 and a third curve section 331-5 that are connected to form an acute angle. Specifically, the retainer 450 is at least partially disposed in the first turning section 331-6 to support the cam follower 124. The retainer 450 has a support surface 451 to which the cam follower 124 may contact.

The retainer 450 may support the cam follower 124 so that the cam follower 124 is not pushed toward the rotation center R of the cam wheel 330 in the first turning section 331-6 by contacting the support surface 451 with the cam follower 124. Accordingly, it is possible to prevent a vibration phenomenon of the display module 110 or a problem in which the display module 110 cannot be bent to a target curvature in the process of bending the display module 110.

The retainer 450 may be formed in various shapes such as a cylindrical shape or a semi-cylindrical shape. Further, the support surface 451 may be formed in an arc shape or a curved shape.

The retainer 450 is supported by the elastic member 453. The elastic member 453 is disposed to apply an elastic force to the retainer 450 in a direction in contact with the cam follower 124. The elastic member 453 may be formed in various shapes capable of applying an elastic force to the retainer 450, such as a polymer or a spring.

As the elastic member 453 applies an elastic force to the retainer 450, the retainer 450 may move in a direction in which the cam follower 124 pushes when the cam follower 124 is in contact. In addition, the retainer 450 may return to its original position when the cam follower 124 is dropped.

The retainer 450 may be formed in a form that may be elastically deformed by itself when the cam follower 124 is in contact therewith. In this case, the elastic member 453 may be omitted.

In the display device according to one or more other embodiments of the present disclosure, a retainer 450 disposed in a sharply bent portion of the cam rail 331 may support the cam follower 124. Accordingly, when the cam follower 124 passes through the sharply bent portion of the cam rail 331, it is possible to prevent the cam follower 124 from being shaken or pushed, and as a result, it is possible to prevent the shaking of the display module 110 or the inability to bend the display module 110 to a target curvature in the process of bending the display module 110.

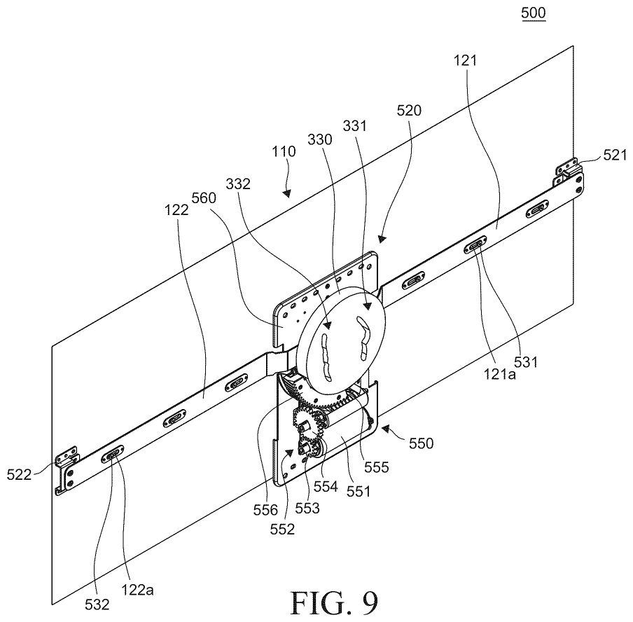

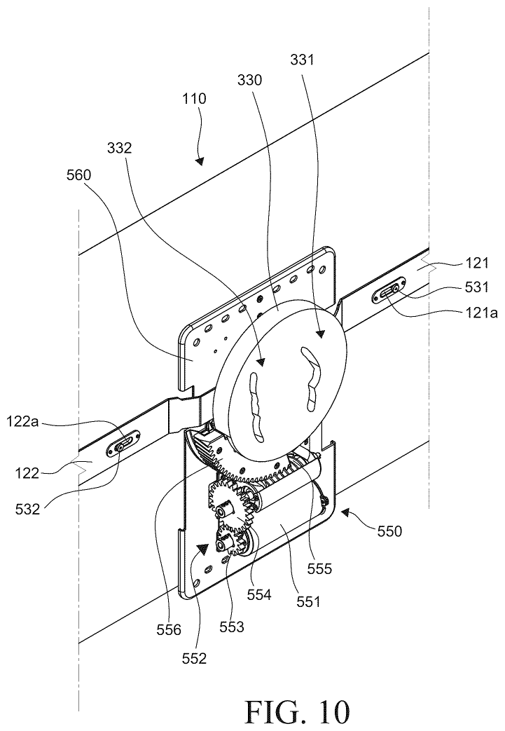

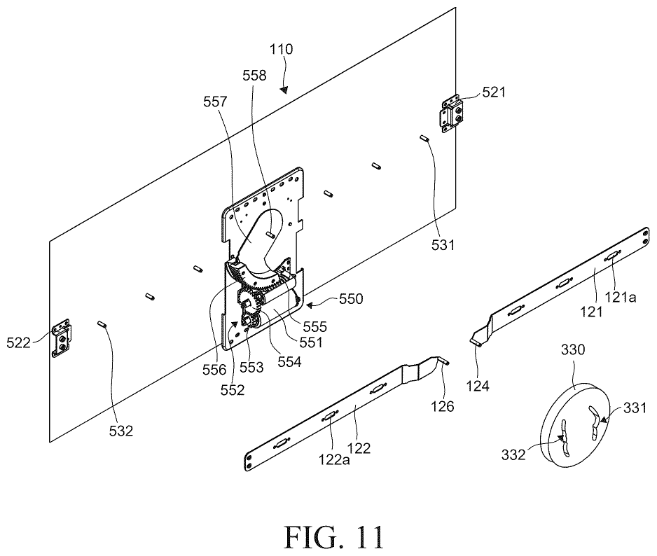

FIG. 9 is a perspective view of a display device according to one or more other embodiments of the present disclosure when viewed from a rear surface. FIG. 10 is an enlarged view of a part of FIG. 9. FIG. 11 is an exploded perspective view of a display device according to one or more other embodiments of the present disclosure.

Referring to FIGS. 9 to 11, a display device 500 according to one or more other embodiments of the present disclosure includes a display module 110 and a bending unit 520.

The bending unit 520 includes a pair of operating arms 121, 122 connected to the display module 110, cam followers 124, 126 respectively disposed on the pair of operating arms 121, 122, a cam wheel 330, and a driving unit 550 providing a rotational force to the cam wheel 330.

The first operating arm 121 is fixed to the display module 110 by a bracket 521. The first operating arm 121 includes a plurality of first operating arm grooves 121a. A plurality of first operating arm grooves 121a are spaced apart from each other in the longitudinal direction of the first operating arm 121. The first operating arm groove 121a extends parallel to the moving direction of the first operating arm 121. A plurality of guides 531 disposed on the rear surface of the display module 110 are inserted into each of the plurality of first operating arm grooves 121a.

The guide 531 guides the first operating arm 121 to move linearly. The guide 531 is formed in the form of a pin inserted into the first operating arm groove 121a. When the first operating arm 121 receives the moving force from the cam wheel 330, the first operating arm 121 is guided by a plurality of guides 531 to stably linearly move. Accordingly, one side portion of the display module 110 may be smoothly bent without the first operating arm 121 being twisted or bent unevenly.

The second operating arm 122 is fixed to the display module 110 by a bracket 522. The second operating arm 122 includes a plurality of second operating arm grooves 122a. The plurality of second operating arm grooves 122a are spaced apart from each other in the longitudinal direction of the second operating arm 122. The second operating arm groove 122a extends parallel to the movement direction of the second operating arm 122. A plurality of guides 532 disposed on the rear surface of the display module 110 are inserted into each of the plurality of second operating arm grooves 122a.

The guide 532 guides the second operating arm 122 to move linearly. The guide 532 is formed in the form of a pin inserted into the second operating arm groove 122a. When the second operating arm 122 receives the moving force from the cam wheel 330, the second operating arm 122 is guided by a plurality of guides 532 to stably linearly move. Accordingly, the other side portion of the display module 110 may be smoothly bent without the second operating arm 122 being distorted or unevenly bent.

The guide structures of the first operating arm 121 and the second operating arm 122 may be variously changed. For example, the guides 531 and 532 for guiding the first operating arm 121 and the second operating arm 122 may be modified into grooves or rails, or other shapes for guiding the first operating arm 121 and the second operating arm 122. In this case, the first operating arm 121 and the second operating arm 122 may be deformed accordingly.

The cam wheel 330 is the same as described above. The cam wheel 330 includes a first cam rail 331 into which a first cam follower 124 disposed on the first operating arm 121 is inserted and a second cam rail 332 into which a second cam follower 126 disposed on the second operating arm 122 is inserted.

The cam wheel 330 is rotated by receiving a rotational force from the driving unit 550.

The driving unit 550 includes a driving source 551 that generates a rotational force, and a power transmission unit 552 that transmits the rotational force of the driving source 551 to the cam wheel 330.

The driving source 551 generates a rotational force for the mechanical operation of the bending unit 520. As the driving source 551, various types of power generating devices such as a motor may be used.

The power transmission unit 552 serves to efficiently transmit the rotational force of the driving source 551 to the cam wheel 330. The power transmission unit 552 is configured to enable precise power transmission through gears that are sequentially connected. The power transmission unit 552 includes a driving gear 553 connected to a driving source 551, a driven gear 554 meshing with the driving gear 553, a worm gear 555 connected with the driven gear 554, a wheel gear 556 meshing with the worm gear 555, and a rotation member 557 engaging with the wheel gear 556.

The driving gear 553 is directly connected to the rotation shaft of the driving source 551 to receive rotational force. The teeth of the driving gear 553 mesh with the teeth of the driven gear 554.

The driven gear 554 receives the rotational force from the driving gear 553 and transmits the rotational force to the worm gear 555. The driven gear 554 may adjust a rotation speed and a torque through a gear ratio with the driving gear 553.

The worm gear 555 is disposed parallel to the central portion of the display module 110. The rotation center axis of the worm gear 555 is orthogonal to the rotation center axis of the cam wheel 330. This orthogonal arrangement has the effect of reducing the thickness of the bending unit 520. That is, due to the arrangement structure of the worm gear 555, the overall thickness of the driving unit 550 is reduced, and as a result, the display device 500 may be thinner and slimmer.

The meshing structure of the worm gear 555 and the wheel gear 556 makes it possible to obtain a large reduction ratio. Accordingly, the high-speed rotation of the driving source 551 may be converted into a precise low-speed rotation of the cam wheel 330. In addition, due to the nature of the worm gear 555 structure, reverse driving is prevented, so that the bending state of the display module 110 may be stably maintained.

On the outer circumferential surface of the wheel gear 556, teeth engaged with the worm gear 555 are formed. When the worm gear 555 rotates, the wheel gear 556 rotates through engagement of these teeth, and this rotational force is transmitted to the cam wheel 330. The wheel gear 556 protrudes from the outer circumferential surface of the cam wheel 330 to be engaged with the worm gear 555.

The rotation member 557 is a component that rotates by being coupled to the wheel gear 556 and rotates together with the cam wheel 330. The cam wheel 330 and the rotation member 557 share a rotation center. A rotation shaft 558 is disposed on the rotation member 557. The rotation shaft 558 connects the rotation member 557 and the cam wheel 330. The cam wheel 330 may rotate about the rotation shaft 558. The rotation member 557 is rotatably coupled to the mount plate 560 fixed to the rear surface of the display module 110.

The mount plate 560 may be coupled to the stand 115 (see FIG. 1). The stand 115 may be coupled to the display module 110 through the mount plate 560. The driving source 551 and the worm gear 555 are disposed on the mount plate 560.

The driving unit 550 may be controlled by the controller to rotate the cam wheel 330 clockwise or counterclockwise by a preset angle. As the driving unit 550 rotates the cam wheel 330, the display module 110 may be bent or restored to its original shape. Further, the driving unit 550 adjusts the rotation angle of the cam wheel 330 to variously change the curvature of the display module 110.

Further, the driving unit 550 may restrict the rotation of the cam wheel 330 in the non-operation state. When the display module 110 is bent by rotating the cam wheel 330 by a predetermined angle, the display module 110 has a force to be restored to its original shape. As a result, the cam wheel 330 receives torque in the opposite direction. In this case, the driving unit 550 restricts the rotation of the cam wheel 330 so that the display module 110 may be maintained in a bent state.

A specific configuration of the driving unit 550 is not limited to that illustrated. For example, the power transmission unit 552 does not include the worm gear 555 and the wheel gear 556 and may be changed to another structure capable of transmitting the rotational force of the driving source 551 to the cam wheel 330, such as another gear connection structure or a link connection structure. Further, the teeth constituting the wheel gear may be integrally disposed on the outer circumferential surface of the rotation member 557.

In the display device 500 according to one or more other embodiments, it is possible to switch between the basic mode and the bending mode. This mode switching may be performed by the bending unit 520.

The mode switching of the display device 500 starts with the operation of the driving source 551.

When switching from the basic mode to the bending mode, the driving source 551 operates to rotate the worm gear 555, and the rotational force of the worm gear 555 is transmitted to the wheel gear 556. Further, the wheel gear 556 rotates the cam wheel 330.

Further, as described above, the display module 110 may be bent by the first cam follower 124 converting the rotational motion of the cam wheel 330 into a linear motion of the first operating arm 121 according to the rotation of the cam wheel 330 and the second cam follower 126 converting the rotational motion of the cam wheel 330 into a linear motion of the second operating arm 122.

Further, the display module 110 may be deformed to the entire bending mode, the first partial bending mode, and the second partial bending mode according to the rotation direction and rotation angle of the cam wheel 330

In the display device 500 according to one or more other embodiments of the present disclosure, the curvature of the display module 110 may be more variously changed by the bending unit 520, thereby providing an optimal viewing experience according to a user's preference or a viewing environment.

Further, in the display device 500 according to one or more other embodiments of the present disclosure, the rotational force of the driving source 551 may be transmitted to the cam wheel 330 through the worm gear 555 which is disposed to be orthogonal to the rotational center axis of the cam wheel 330. Accordingly, the display device 500 may be thinner and slimmer. In addition, due to the nature of the worm gear 555 structure, reverse driving is prevented, so that the bending state of the display module 110 may be stably maintained.

Embodiments of the present disclosure can also be described as follows:
A display device according to one or more other embodiments of the present disclosure includes a display module and a bending unit for bending the display module, and the bending unit include a cam wheel rotatably disposed on a rear surface of the display module, and an operating arm connected to the display module for bending the display module and linearly moving by the rotation of the cam wheel.

According to one or more embodiments of the present disclosure, the display device may further include a driving unit that provides a rotational force to the cam wheel.

According to one or more embodiments of the present disclosure, the driving unit may include a wheel gear connected to the cam wheel to share a rotation center with the cam wheel, a worm gear engaged with the wheel gear, and a driving source connected with the worm gear.

According to one or more embodiments of the present disclosure, the worm gear may be disposed in a direction orthogonal to the rotation central axis of the cam wheel.

A display device according to one or more other embodiments of the present disclosure includes a display module and a bending unit disposed on a rear surface of the display module and bending the display module, the bending unit includes a cam wheel including a first cam rail and a second cam rail, a first operating arm and a second operating arm respectively connected to the display module, a first cam follower connected to the first operating arm so as to move along the first cam rail and converting the rotational movement of the cam wheel into a linear movement of the first operating arm, and a second cam follower connected to the second operating arm so as to move along the second cam rail and converting the rotational movement of the cam wheel into a linear movement of the second operating arm.

According to one or more embodiments of the present disclosure, one end of the first cam rail and one end of the second cam rail may be located on a virtual first concentric circle sharing a rotation center with the cam wheel, and the other end of the first cam rail and the other end of the second cam rail may be located on a virtual second concentric circle which is larger than the first concentric circle and sharing a rotation center with the cam wheel.

The second cam rail may have an arc shape disposed on the first concentric circle.

According to one or more embodiments of the present disclosure, the first cam rail and the second cam rail may have different shapes, a part of the first cam rail may be located on a virtual first concentric circle sharing a rotation center with the cam wheel, another part of the first cam rail may be located on a virtual second concentric circle which is larger than the first concentric circle and sharing a rotation center with the cam wheel, a part of the second cam rail may be located on the first concentric circle, and another part of the second cam rail may be located on the second concentric circle.

According to one or more embodiments of the present disclosure, the bending unit is configured to switch the bending mode for the display module, and the bending mode may include a first partial bending mode for bending one side portion of the display module, a second partial bending mode for bending the other side portion of the display module, and an entire bending mode for bending both side portions of the display module.

According to one or more embodiments of the present disclosure, in the first partial bending mode, the second cam follower is located on the first concentric circle, the first cam follower is located on the second concentric circle, the first operating arm bends one side portion of the display module, and in the second partial bending mode, the first cam follower is located on the first concentric circle, the second cam follower is located on the second concentric circle, the second operating arm bends the other side portion of the display module, and in the full bending mode, both the first cam follower and the second cam follower are located on the second concentric circle, and the first operating arm and the second operating arm may bend both side portions of the display module.

The first cam rail may include a first end section positioned on a first concentric circle, a second end section positioned on a second concentric circle, a plurality of curve sections connecting the first end section and the second end section, and at least one turning section disposed between the plurality of curve sections.

According to one or more embodiments of the present disclosure, the turning section may be disposed on the first concentric circle or the second concentric circle.

According to one or more embodiments of the present disclosure, the plurality of curve sections may include a first curve section connected to the first end section, a second curve section connected to the second end section, and a third curve section connecting the first curve section and the second curve section, the first curve section and the third curve section may be connected through a first turning section disposed on the second concentric circle, and the second curve section and the third curve section may be connected through a second turning section disposed on the first concentric circle.

The second cam rail may include a third end section and a fourth end section disposed to be spaced apart on the second concentric circle, a fourth curve section connected to the third end section, a fifth curve section connected to the fourth end section, a sixth curve section connecting the fourth curve section and the fifth curve section, a third turning section disposed on the first concentric circle to connect the fourth curve section and the sixth curve section, and a fourth turning section disposed on the first concentric circle to connect the fifth curve section and the sixth curve section.

According to one or more embodiments of the present disclosure, the display device may further include a retainer having a support surface disposed in the turning section to support the first cam follower so that the first cam follower is not pushed toward a rotation center of the cam wheel in the turning section.

According to one or more embodiments of the present disclosure, the display device may further include an elastic member disposed to apply an elastic force to the retainer in a direction in contact with the first cam follower.

Although the embodiments of the present disclosure have been described in detail with reference to the accompanying drawings, the present disclosure is not limited thereto and may be embodied in many different forms without departing from the technical concept of the present disclosure. Therefore, the embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure. All the technical concepts in the equivalent scope of the present disclosure should be construed as falling within the scope of the present disclosure.

What is claimed is:

1. A display device, comprising:
a display module; and
a bending unit for bending the display module, wherein the bending unit comprises:
a cam wheel rotatably disposed on a rear surface of the display module; and
an operating arm connected to the display module for bending the display module, the operating arm linearly moving by a rotation of the cam wheel.

2. The display device according to claim 1, further comprising:
a driving unit which provides a rotational force to the cam wheel.

3. The display device according to claim 2, wherein the driving unit includes:
a wheel gear connected to the cam wheel so as to share a rotation center with the cam wheel;
a worm gear meshing with the wheel gear; and
a driving source connected to the worm gear.

4. The display device according to claim 3, wherein the worm gear is disposed in a direction orthogonal to a rotation center axis of the cam wheel.

5. A display device, comprising:
a display module; and
a bending unit disposed on a rear surface of the display module and bending the display module,
wherein the bending unit comprises:
a cam wheel including a first cam rail and a second cam rail;
a first operating arm and a second operating arm respectively connected to the display module;
a first cam follower connected to the first operating arm so as to move along the first cam rail and convert a rotational movement of the cam wheel into a linear movement of the first operating arm; and
a second cam follower connected to the second operating arm so as to move along the second cam rail and convert a rotational movement of the cam wheel into a linear movement of the second operating arm.

6. The display device of claim 5, wherein a first end of the first cam rail and a first end of the second cam rail are located on a virtual first concentric circle sharing a rotation center with the cam wheel,
wherein a second end of the first cam rail and a second end of the second cam rail are located on a virtual second concentric circle, and
wherein the virtual second concentric circle is larger than the virtual first concentric circle and shares a rotation center with the cam wheel.

7. The display device of claim 5, wherein the second cam rail has an arc shape disposed on a virtual first concentric circle.

8. The display device of claim 5, wherein the first cam rail and the second cam rail have different shapes,
wherein a first part of the first cam rail is located on a virtual first concentric circle sharing a rotation center with the cam wheel,
wherein a second part of the first cam rail is located on a virtual second concentric circle which is larger than the virtual first concentric circle, the virtual second concentric circle sharing the rotation center with the cam wheel,
wherein a first part of the second cam rail is located on the virtual first concentric circle, and
wherein a second part of the second cam rail is located on the virtual second concentric circle.

9. The display device according to claim 8, wherein the bending unit is configured to switch a bending mode for the display module, and wherein the bending mode includes:
a first partial bending mode in which a first side portion of the display module is bent;
a second partial bending mode in which a second side portion of the display module is bent; and
an entire bending mode in which both the first side portion of the display module and the second side portion of the display module are bent.

10. The display device of claim 9, wherein in the first partial bending mode, the second cam follower is located on the virtual first concentric circle, the first cam follower is located on the virtual second concentric circle, and the first operating arm bends the first side portion of the display module,
wherein in the second partial bending mode, the first cam follower is located on the virtual first concentric circle, the second cam follower is located on the virtual second concentric circle, and the second operating arm bends the second side portion of the display module, and
wherein in the entire bending mode, both the first cam follower and the second cam follower are located on the virtual second concentric circle, and the first operating arm and the second operating arm bend both the first side portion of the display module and the second side portion of the display module.

11. The display device of claim 8, wherein the first cam rail comprises:
a first end section positioned on the virtual first concentric circle;
a second end section positioned on the virtual second concentric circle;
a plurality of curve sections connecting the first end section and the second end section; and
at least one turning section disposed between the plurality of curve sections.

12. The display device according to claim 11, wherein the at least one turning section is disposed on the virtual first concentric circle or the virtual second concentric circle.

13. The display device of claim 12, wherein the plurality of curve sections include:
a first curve section connected to the first end section;
a second curve section connected to the second end section; and
a third curve section connecting the first curve section and the second curve section,
wherein the first curve section and the third curve section are connected through a first turning section disposed on the virtual second concentric circle, and
wherein the second curve section and the third curve section are connected through a second turning section disposed on the virtual first concentric circle.

14. The display device of claim 13, wherein the second cam rail comprises:
a third end section and a fourth end section disposed to be spaced apart on the virtual second concentric circle;
a fourth curve section connected to the third end section;
a fifth curve section connected to the fourth end section;
a sixth curve section connecting the fourth curve section and the fifth curve section;
a third turning section disposed on the virtual first concentric circle to connect the fourth curve section and the sixth curve section; and
a fourth turning section disposed on the virtual first concentric circle to connect the fifth curve section and the sixth curve section.

15. The display device of claim 12, further comprising:
a retainer having a support surface disposed in the at least one turning section to support the first cam follower so that the first cam follower is not pushed toward the rotation center of the cam wheel.

16. The display device of claim 15, further comprising:
an elastic member disposed to apply an elastic force to the retainer in a direction in contact with the first cam follower.

17. A display device, comprising:
a display module; and
a bending unit disposed on a surface of the display module, the bending unit configured to bend the display module,
wherein the bending unit comprises:
a cam wheel including a first cam rail and a second cam rail;
a first cam follower connected to the first cam rail;
a second cam follower connected to the second cam rail;
a first operating arm connected to the first cam follower and a first side portion of the display module, the first operating arm configured to apply a force capable of bending the first side portion of the display module; and
a second operating arm connected to the second cam follower and a second side portion of the display module, the second operating arm configured to apply a force capable of bending the second side portion of the display module,
wherein the display module is bent by at least one of a movement of the first operating arm and a movement of the second operating arm due to at least one of a movement of the first cam follower along the first cam rail and a movement of the second cam follower along the second cam rail, caused by a rotational movement of the cam wheel.

18. The display device of claim 17, wherein the first side portion of the display module is bent and the second side portion of the display module is not bent when, caused by a first rotational movement of the cam wheel, the first cam follower moves from a virtual first concentric circle to a virtual second concentric circle and the second cam follower stays on the virtual first concentric circle,
wherein the first side portion of the display module is not bent and the second side portion of the display module is bent when, caused by a second rotational movement of the cam wheel, the first cam follower moves from the virtual second concentric circle to the virtual first concentric circle and the second cam follower moves from the virtual first concentric circle to the virtual second concentric circle,
wherein the virtual second concentric circle is larger than the virtual first concentric circle, and
wherein the virtual first concentric circle and the virtual second concentric circle share a rotation center with the cam wheel.

19. The display device of claim 17, wherein the first side portion of the display module is bent and the second side portion of the display module is bent when, caused by the rotational movement of the cam wheel, the first cam follower moves from a virtual first concentric circle to a virtual second concentric circle and the second cam follower moves from the virtual first concentric circle to the virtual second concentric circle,
wherein the virtual second concentric circle is larger than the virtual first concentric circle, and
wherein the virtual first concentric circle and the virtual second concentric circle share a rotation center with the cam wheel.

20. The display device of claim 17, wherein the first side portion of the display module is bent and the second side portion of the display module is bent when, caused by the rotational movement of the cam wheel, the first cam follower moves from a first position on the cam wheel to a second position on the cam wheel and the second cam follower moves from a third position on the cam wheel to a fourth position of the cam wheel.
